(19) United States
(12) Patent Application Publication
(10) Pub. No.: US 2009/0206286 A1
(43) Pub. Date: Aug. 20, 2009

(54) System and method for particle stream characterization

(76) Inventors: Dario Pierri, Arbon (CH); Jochen Lisner, Niederuzwil (CH); André Ruegg, Kloten (CH); Phillip Geissbuhler, Brighton, MA (US)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/919,617

(22) PCT Filed: Jul. 21, 2005
(86) PCT No.: PCT/CH2005/000429

§ 371 Date: Oct. 30, 2007

(30) Foreign Application Priority Data
May 2, 2005 (CH) PCT/CH2005/000429

(51) Int. Cl. G01N 21/85

(52) U.S. Cl. 250/576; 356/440

(57) ABSTRACT

The invention relates to a system and method for characterization of a particle flow, for example, for characterization of material for milling, in particular for milled cereals, in a roller frame with a roller passage formed by a pair of rollers whereby the system comprises a withdrawal portion after the roller passage for removal of a milled material sample from the milled material flow exiting the roller passage, a presentation section for conveying and presenting the taken milled material sample, a recording device for recording the milled material passing through the presentation section and an analytical section for analysis of the recorded milled material sample.

### CROSS-REFERENCE TO RELATED APPLICATIONS

This is a national phase application of International Application No. PCT/CH2005/000429, filed Jul. 21, 2005 which claims priority of International Application No. PCT/CH2005/000242, filed May 2, 2005, the complete disclosures of which are hereby incorporated by reference.

### BACKGROUND OF THE INVENTION

a) Field of the Invention

The invention relates to a system and method for characterizing a particle stream, wherein at least the shape, size or motion of the individual particles is determined.

The particle stream is a stream of powdery to grainy bulk material, in particular grain, flour, sugar, pigments, chemicals, pharmaceuticals, dust emissions, soot particles, toner powder, etc.

b) Description of the Related Art

When milling grainy materials, e.g., wheat or sugar, in a roll mill, the grainy material is comminuted between the rolls of the roll pair. For example, to obtain flour of a specific fineness, the grinding stock must usually be fed repeatedly through such a passage, wherein grading via air separation and screening takes place between runs. This makes it possible to obtain flours with varying degrees of fineness or milling.

The milling effect of a passage depends primarily on the nip gap between the two rolls of a roll pair. However, there are other roll mill operating parameters that influence the milling effect of a passage. Therefore, it would be desirable to obtain a characterization of the grinding material that exits after a specific passage. If the grinding material deviates from a set grinding material characteristic in the process, this deviation can be used as the basis for correcting the nip gap or whatever other roll mill operating parameter required so as to compensate for the deviation as quickly as possible.

EP 0 433 498 A1 describes a roll mill in which a portion of the grinding material is diverted and passed by a measuring unit that determines the particle size of the grinding material particles.

WO 01/03841 A1 describes a control system for milling processes. Here as well, grinding material particles are passed by a measuring unit that determines the size of the grinding material particles.

EP 0 487 356 A2 describes a method and device for determining the level of milling in a milling system in which grinding material grains are passed between a coherent light source and light receiver to determine the particle sizes, and hence the level of milling, of the grinding material.

### OBJECT AND SUMMARY OF THE INVENTION

The primary object of the invention is to provide a system and method that make it possible to characterize a particle stream, in particular of the grinding material exiting a milling passage in a roll mill.

This object is achieved by the system according to the invention for characterizing the particles in a particle stream comprising removal means for taking a sample out of the particle stream, a presentation section for conveying and presenting the sample taken, acquisition means for detecting the sample conveyed through the presentation section and analyzing means for analyzing the detected sample. The detection means has a camera with a visual field for detecting electromagnetic radiation or electromagnetic frequencies such as optical frequencies. Opposing walls of the presentation section are permeable to electromagnetic radiation detectable by the camera including optical frequencies. The camera is situated downstream on one side of a gap on one of two permeable walls. An electromagnetic radiation source, such as a light source, for the electromagnetic radiation detectable by the camera is situated downstream on the other side of the gap on the other of the two permeable walls, so that the sample particles conveyed through the gap can be radiated by the electromagnetic radiation, and the shadow or projection of the sample particles gets into the visual field of the camera. The object is also achieved by a method for characterizing the particles in a particle stream using a system as described above comprising the steps of taking a sample from the particle stream, conveying and presenting the sample taken in a presentation section, detecting the sample conveyed through the presentation section, analyzing the detected sample and radiating the sample particles conveyed through the gap by the electromagnetic radiation, and allowing the shadow or projection of the sample particles to get into the visual field of the camera.

The system according to the invention encompasses a removal means for taking a sample out of the particle stream; a presentation section for conveying and presenting the sample taken; an acquisition means for detecting the sample conveyed through the presentation section; and an analyzing means for analyzing the detected sample; wherein the acquisition means has a camera for detecting electromagnetic radiation or electromagnetic frequencies, in particular optical frequencies.

According to the invention, the opposing walls of the presentation section are permeable to electromagnetic radiation detectable by the camera, in particular optical frequencies. As a result, the camera can be optionally arranged on either side of the gap behind the walls.

In this arrangement according to the invention, the camera is situated downstream on one side of the gap on one of the two permeable walls, and an electromagnetic radiation source, in particular a light source, for the electromagnetic radiation detectable by the camera is situated downstream on the other side of the gap on the other of the two permeable walls. As a result, the sample particles conveyed through the gap can be radiated by the electromagnetic radiation, and the shadow or projection of the sample particles gets into the visual field of the camera.

The method according to the invention involves the following steps: taking sample from the particle stream; conveying and presenting the sample taken in a presentation section; detecting the sample conveyed through the presentation section; and analyzing the detected sample.

This makes it possible to characterize the particle stream, in particular the grinding material that exits a milling passage.

A deagglomeration section is preferably provided downstream from the removal means and upstream from or in the presentation section for deagglomerating particle agglomerates in the sample. This prevents agglomerates of several particles from being mistakenly detected and identified as large particles.

A pneumatic line can be used to connect the removal means with the presentation section in such a way that the sample can be conveyed through the pneumatic line and presentation section along a flow path. In this way, the system according to the invention can also be secured inside a mill at a location remote from the roll mill, increasing the artistic freedom when designing a mill system.

The presentation section best has two opposing walls, between which a gap is formed, wherein the two opposing walls are preferably flat surfaces arranged parallel to each other.

The pneumatic line mentioned further above best ends in a port area in the gap formed between the opposing walls, wherein the flow path in the port area preferably exhibits a directional change. This causes the grinding material entrained in the conveying gas of the pneumatic line to collide against the line wall, helping to deagglomerate potentially present agglomerates. The directional change in the flow path measures between 30° and 90° in particular, preferably measuring 80° to 90°. This results in particularly large pulse changes for the entrained particles during their deflective collisions, and hence in an especially pronounced impact effect.

In this first arrangement, the camera is situated downstream on one side of the gap on one of the two permeable walls, and an electromagnetic radiation source, in particular a light source, for the electromagnetic radiation detectable by the camera is situated downstream on the other side of the gap on the other of the two permeable walls. As a result, the sample particles conveyed through the gap can be radiated by the electromagnetic radiation, and the shadow or projection of the sample particles gets into the visual field of the camera.

In a second variant, the first wall of the two opposing walls of the presentation section is permeable to electromagnetic radiation detectable by the camera, in particular to optical frequencies, while the second wall is impermeable to electromagnetic frequencies detectable by the camera, in particular optical frequencies, and is more absorbent than the grinding material particles.

In this second arrangement, the camera is situated downstream on the one side of the gap on the permeable wall, and an electromagnetic radiation source, in particular a light source, is arranged downstream on the same side of the gap on the permeable wall. As a result, the sample particles conveyed through the gap can be irradiated, and the scattered light or reflection of sample particles gets into the visual field of the camera.

It is here advantageous for the surface of the second wall on the side of the gap to absorb more of the electromagnetic radiation emitted by the source than the particle surfaces. This ensures a sufficient level of contrast between the reflecting particles moving in front of the surface on the side of the gap and the light reflected by the wall, making it easy to detect the imaged particles and significantly facilitating subsequent image processing. This saves on expensive and time-consuming filtering process during image processing.

In an advantageous further development, a cleaning device is allocated to the respective opposing walls, and can be used to remove particles adhering to the two opposing walls. This ensures that the camera does not image too many resting particles, i.e., particles adhering to one or the other wall. The particle size distribution of the particles adhering to the walls is generally different than that for the particles entrained in the particle stream. If the goal during the acquisition and processing of particle stream image information is not to have to distinguish between resting and moving particles, the walls should be routinely cleaned in this way to “shake off” particles adhering to the walls.

The cleaning device can be a vibration source, in particular an ultrasound source, which is rigidly secured to the respective two opposing walls, so that the two walls can be made to vibrate. We also refer to this version as the “structure-borne noise version” of the cleaning device.

As an alternative, the cleaning device can also be a vibration source, in particular an ultrasound source, with which the gaseous medium between the two opposing walls can be made to vibrate. We also refer to this version as the “airborne noise version” of the cleaning device.

The deagglomeration section is preferably an impact surface in the entry area of the presentation section. In addition to the deagglomeration effect achieved by imparting impact and pulses to the agglomerates, the airborne noise version of the wall cleaning device can also be used to deagglomerate the particles carried in the air, wherein various ultrasound frequencies are used either successively or simultaneously, as required.

The directional change in the flow path preferably takes place in the entry area of the presentation section. As a result, the collision occurs just prior to optically detecting the particle stream, so that the particles are practically completely deagglomerated from each other.

In this conjunction, it must also be mentioned that it is also particularly advantageous to provide openings in the pneumatic line upstream just before the presentation section, so as to aspirate ambient air (“secondary air”) via the pneumatic line operated at a slight underpressure. This inwardly transferred secondary air, pulsed if necessary, also helps to clean the wall and deagglomerate.

The presentation section or “window” is best larger than the visual field of the camera, in which case the camera then only acquires a partial area of the presentation section. This makes it possible to place the camera inside the presentation area in a location on the wall or window where minimal separation of particles within the particle stream is expected.

If the presentation section or window is larger than the visual field of the camera, several cameras can also acquire a partial area of the presentation section. This makes it possible to average different particle stream images of various locations within the presentation section. If the particle stream separates in the various partial areas, this averaging can produce a normalization that at least partially offsets this separation, so that the averaged totality of information from the respective particle stream images is representative for the particle size distribution in the entire particle stream.

In a special embodiment, the several cameras can each be selectively activated, so that selective sections of the particle stream image on the image sensor can be used and can be averaged.

As an alternative, the presentation section can essentially correspond to the entire visual field of the camera, wherein the image sensor of the camera can then be selectively actuated, so that selective sections of the particle stream image on the image sensor can be used. Such a selective actuation preferably takes place purely randomly, specifically and in particular through actuation by means of a random-check generator.

In an advantageous further development, the system according to the invention is allocated to a cylinder mill, and encompasses several removal means after the roll passage arranged along the axial direction of a roll passage, wherein a first removal means is preferably situated in the area of the first axial end of the roll passage, and a second removal means is preferably situated in the area of the second axial end of the roll passage. This makes it possible to obtain information about the level of milling as a function of the axial position along the roll pair. In the case of nonsymmetrical grinding material characteristics along the roll pair or in particular between the left and right end area of the roll passage, a faulty alignment of the rolls of the roll pair can be deduced and corrected.

The light source and camera are best connected with a controller, which can synchronously turn the light source and camera on and off, so that a sequence of stroboscopic pictures are taken. Several light sources or stroboscopic flashes can also be provided, which are operated simultaneously, but differently, specifically and in particular with respect to flash duration and intensity.

The analyzing means preferably has an image processing system.

This image processing system preferably has means for taking the particles imaged and detected by the camera in the projection mode or reflection mode and distinguish between moving particles and particles adhering to the walls. The resting particles adhering to the wall can then be excluded from evaluation during image processing, so that only the moving particles are used for the assessment. In much the same way as described above, this avoids a distortion of the particle size distribution of the particle stream.

While implementing the method according to the invention on a cylinder mill, the grinding material sample is preferably taken from the grinding material stream exiting the roll passage at various points, so that information can be gleaned about the relative roll alignment of the roll pair of the passage, as explained further above.

The grinding material sample obtained in this way is then preferably conveyed through the presentation section in a radial stream. In such a radial stream, the radial flow rate tapers off in a radial direction from the inside out. The transport fluid (e.g., pneumatic air) is radially loaded as constantly as possible from the inside out., i.e., the number of grinding material particles per unit of volume is essentially also constant to the outside, so that the probability of particle overlap while imaging the projection picture or reflection picture over the radial area is essentially constant. A partial detection area can be radially positioned by radially shifting the camera to then arrive at an optimal balance between a sufficiently dense loading of the grinding material stream to achieve a representative image on the one hand, and adequate dilution of the grinding material stream to prevent particle images from converging in the camera to the greatest extent possible (no “optical agglomerates”) on the other.

Allowing secondary air to stream into the radially inner part of the detection area makes it possible to vary the load of transport fluid.

In order to cut down on computing time during image processing, it definitely makes sense to detect the particle stream passed through the presentation section in partial areas only. Over the course of the entire detection process, at least one switch is made, e.g., between a first partial area where a first part of the detection takes place to at least one additional partial area where another part of the detection subsequently takes place. The evaluation results for the various partial detection areas can then be averaged to achieve as representative a characterization of the entire particle stream as possible. The respectively detected partial areas of the presentation section are preferably selected at random.

As already mentioned, it is particularly advantageous for a continuous deagglomeration of particle agglomerates to take place in the particle stream before and/or during passage of the particle stream through the presentation section. On the one hand, deagglomeration can here take place before the particle stream passes through the presentation section predominantly through deflection and impact. On the other hand, deagglomeration can take place as the particle stream passes through the presentation section primarily through turbulence in the pneumatic particle stream.

The samples taken are best pneumatically conveyed before removed, wherein the samples are preferably removed, presented, detected and analyzed continuously. For example, this yields a seamless monitoring of the milling process and grinding quality as a result of characterizing the grinding material stream generated by the milling process. This can also be drawn upon in a particularly advantageous way to control the milling process, in particular for setting the milling gap.

The continuous particle stream is best detected stroboscopically through a series of stroboscopic flashes.

The following abbreviations are used below:
v=average flow rate of pneumatic medium;
D=average particle dimensions or average particle size of particles;
Dmin=minimum particle dimensions of a particle;
Dmax=maximum particle dimensions of a particle.

Detection preferably takes place with a series of stroboscopic flashes, which exhibits a first partial series of stroboscopic flash still pictures with a first activation time T1 and first light intensity L1, and a second partial series of stroboscopic flash trajectory pictures with a second activation time T2 and a second light intensity L2, wherein the following relationship is satisfied: T2≧2 T1.

As a rule, it can be assumed for a grinding material that Dmax≦2 Dmin. If the activation time T2 of the stroboscopic flash trajectory images is at least twice as long as the activation time T1 of the stroboscopic flash still pictures, a stroboscopic trajectory image of a particle will always differ from a stroboscopic still image of an extremely oblong particle for which Dmax=2 Dmin. As a result, such an image of the shortest possible trajectory will not be confused with the image of a resting, oblong particle during evaluation.

A deactivation time T3 between a stroboscopic flash still image and stroboscopic flash trajectory image preferably satisfies the relationship 2 D<v T3.

This ensures that the images of a grinding material particle will not overlap as the result of two consecutive stroboscopic flash still images, which is advantageous for some image sensors, e.g., charge-coupled devices (CCD).

The deactivation time T3 between the stroboscopic flash still image and the stroboscopic flash trajectory image preferably satisfies the relationship 2 D<v T3<10 D, and in particular the relationship 2 D<v T3<7 D.

As a consequence, the distance between the respective still image and respective trajectory is not too great for the moving particles imaged once as a still and once as a trajectory, thereby enabling a clear allocation between the respective still image and accompanying respective trajectory of a moving particle.

In order to obtain sufficiently sharp, i.e., virtually “non-fuzzy” or “non-blurry” still images of the moving particles, the activation time T1 of the stroboscopic flash still images should satisfy the relationship v T1<<D, and in particular the relationship v T1<D/10.

To obtain clear trajectory images that cannot be confused with still images of extremely oblong particles, the activation time T2 of the stroboscopic flash trajectory images should satisfy the relationship v T2>D, and in particular the relationship v T2≧5 D.

Independently of the features mentioned above, it is advantageous if the light intensity L1 of the stroboscopic flash still images and light intensity L2 of the stroboscopic flash trajectory images are different from each other. This can also be drawn upon for distinguishing between the resultant stills and trajectory images.

The particle stills, to which a particle trajectory can be allocated, can be stored in a first still image memory, so that the respective particle still image information is stored in a still image memory for each completed stroboscopic flash still image and stroboscopic flash trajectory image;

The particle still image information for consecutive stills can then be statistically evaluated, in particular to determine the average particle size D, its standard deviation, and its statistical distribution. This can be represented by means of distribution function (differentiated) or histogram (integrated).

The system according to the invention can be used as a grinding material characterization system. It is preferably used in a mill, and is there allocated to a respective cylinder mill in order to characterize the respective grinding material (e.g., flour, sugar, pigments, etc.).

The following are also best allocated to this cylindrical mill:
A comparison device for comparing a determined grinding material characteristic with a desired grinding material characteristic; and
A setting a setting device for setting the gap distance or another cylinder mill operating parameter as a function of a deviation between the determined grinding material characteristic and the desired grinding material characteristic.

This makes it possible to control and regulate in particular the roll gap of the cylinder mills in a mill.

Additional advantages, features and possible applications of the invention can now be gleaned from the following description of embodiments based on the drawing, which are not to be construed as limiting.

### BRIEF DESCRIPTION OF THE DRAWINGS

In the drawings:

FIG. 1 is a diagrammatic side view of part of a system according to the invention to illustrate the path followed by the grinding material stream;

FIG. 2 is a block diagram of another part of the system according to the invention to illustrate its means for determining and processing grinding material information;

FIG. 3 is a part of the process of determining and processing grinding material information; and

FIG. 4 is a special aspect involving the determination and processing of grinding material information.

### DESCRIPTION OF THE PREFERRED EMBODIMENTS

FIG. I shows a diagrammatic side view of a part of a system according to the invention to illustrate the path followed by the grinding material stream. A roll pair 2, 4 forms a milling passage 6 of a cylinder roll. After milled in the milling passage 6, the grinding material 1 denoted schematically by solid points, which involves wheat flour with particle sizes within the range of several 100 μm, passes into a funnel 8 into which a pneumatic line 18 ends. This pneumatic line 18 transports the grinding material I to a gap 10 extending between a first wall 20 and a second wall 22, which are aligned parallel to each other. The grinding material I enters into the gap 10 in a port area 19 and moves then radially from this port area 19 to the outside to enter a transitional area 28, through which it is conveyed downward pneumatically and by the force of gravity, and gets into another pneumatic line 30.

In a first version (projection version), a camera 12 aimed at the gap 10 is situated above the light-permeable wall 20. Situated below the light-permeable wall 22 is a light source 24, which radiates through the gap 10 between the two walls 20, 22. The camera 12 detects the shadows projected by the grinding material particles I on its image sensor.

In a second version (reflection version, not shown), the light source 24 can alternatively be situated above the light-permeable wall 20 next to the camera 12. In this case, the lower wall 22 is impermeable to light, and has a dark surface on the side of the gap 10. The camera 12 detects the light reflected or scattered by the grinding material particles on its image sensor.

The light source 24 is operated as a stroboscope. As a result, the shadows of the grinding material particles (version according to the invention) or images of the grinding material particles (second version) are imaged on the image sensor of the camera 12 as still images. These grinding material stream stills represent instantaneous photographs of the grinding material stream in the gap 10. This image information is routed to an image processing system 14 downstream from the camera 12, where the grinding material stills are processed so that statistical conclusions can be drawn about the size distribution of the grinding material particles.

The port area 19 incorporates a deagglomeration section 16 in the form of a baffle plate. The grinding material particles I transported in via the pneumatic line 18 strike this baffle plate 16, upon which the conveying air divert them by about 90° before they arrive in the gap 10 between the two parallel walls 20, 22. This effectively detaches agglomerates under the grinding material particles, and deagglomerated grinding material particles get into the gap 10. In this way, agglomerates in the grinding material are prevented from distorting grinding material characterization.

The port area 19 also incorporates an opening 38, which extends annularly around the pneumatic line 18. Ambient air or “secondary air” gets into the gap through this opening 38, since the pneumatic lines 18, 28 and 30 are operated under a slight underpressure. The secondary air entering through this secondary air opening 38 cleans the insides of the walls 20, 22, thereby preventing the gap 10 from becoming stopped up.

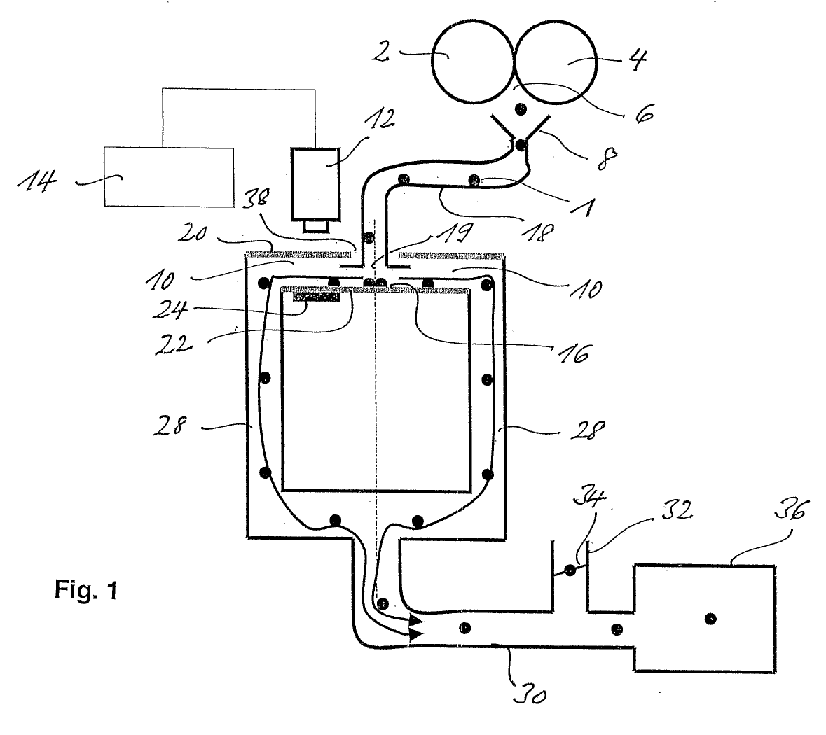

The pneumatic line 30 again empties into the line leading away from the cylinder mill (not shown). As a result, the removed grinding material sample 1 is returned to the mill via an air intake (not shown), in order to be further ground, screened or air separated, as required. FIG. 1 schematically denotes this “siphoning” back into the mill circulation via a vacuum cleaner 36.

The pneumatic line 30 also incorporates a branch 32 forming a bypass to the suction device 36. This branch line 32 has a throttle valve 34 with which the flow resistance of the branch line 32 can be set. This makes it possible to adjust the overall flow resistance of the parallel circuit formed by the suction device 36 and branch line 32, and hence the flow rate in the pneumatic lines 18, 28 and 30. In other words, the throttle valve 34 of the branch line 32 can be used to modulate the suction capacity of the mill (or “vacuum cleaner” 36). As a result, the suction capacity can be precisely regulated.

To achieve optimal operation of the system according to the invention for grinding material characterization, the grinding material density must not be excessive on the one hand. On the other hand, the grinding material velocity, flash duration and flash intensity of the stroboscopic lamp 24 along with the sensitivity and optical resolution of the camera 12 must be harmonized to obtain sufficiently bright and sharp shadows or images of the grinding material particles.

Since the grinding material in the gap 10 between the plates 20, 22 streams radially from the inside out, the grinding material density and radial flow rate taper off radially from the inside out. Therefore, the camera position and lamp position can be shifted radially via the light-permeable wall 20 under prescribed flow conditions in the pneumatic lines 18, 28, 32 to make use of an optimal particle density and particle velocity for detecting and analyzing the image information.

Regardless of the radial camera and lamp position, the particle density can also be set by positioning the funnel below the roll passage 6 and/or via the size of the funnel opening.

Both the particle density and particle velocity in the gap 10 can also be set by adjusting the gap distance, i.e., by setting the distance between the walls 20, 22.

Therefore, the system according to the invention offers great latitude in setting the particle density and particle velocity, which are roughly adjusted primarily based on the position of the funnel 8, the wall distance in gap 10, and the quantity of secondary air supplied via the opening 38, while precision adjustment takes place primarily via the throttle valve 34 in the branch line 32.

In addition to generally cleaning the walls 20, 22 by supplying secondary air, the walls can also be cleaned more thoroughly through vibration, in particular ultrasound, wherein the walls 20, 22 can be vibrated directly and/or indirectly by the air in the gap 10 (structure-borne or air-borne noise). Continuously cleaning the wall surfaces, or more accurately keeping them clean at all times, is important to prevent too many resting grinding material particles from being detected by the camera in addition to the moving grinding material particles in the form of still photographs. On the one hand, this could result in distortions in grinding material characterization, since the size distribution of particles adhering to the wall is generally not identical to the particle size distribution of the transported grinding material. On the other hand, too many grinding material particles adhering to the wall yields a very high particle density in the visual field of the camera, and hence to numerous overlaps of shadows or images of the grinding material particles.

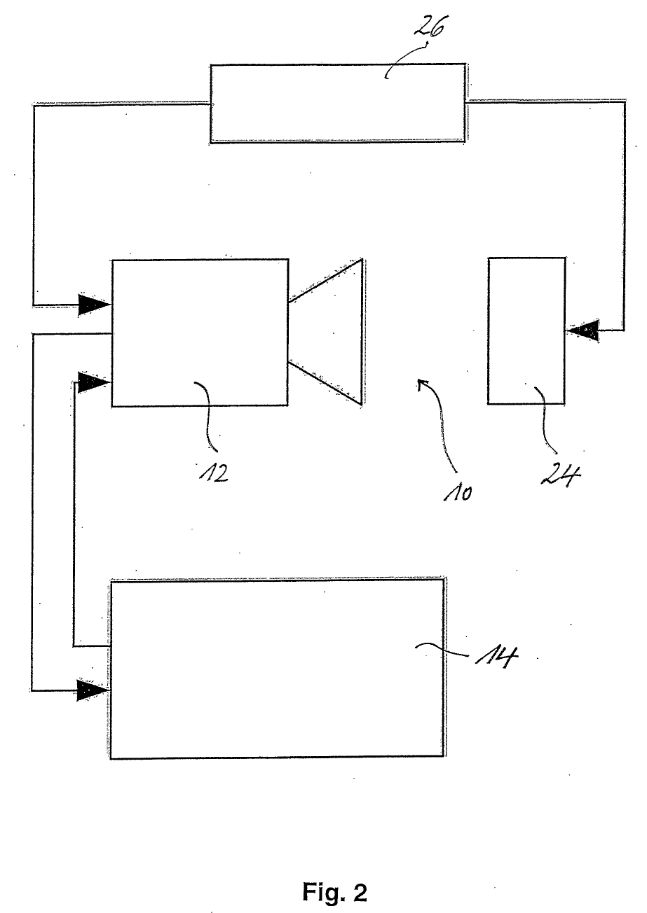

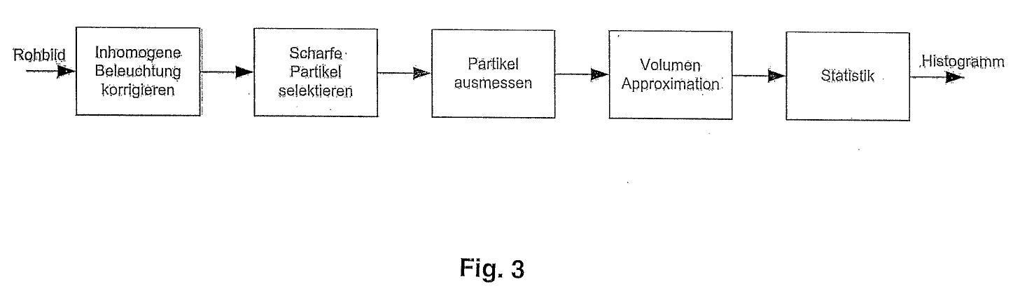

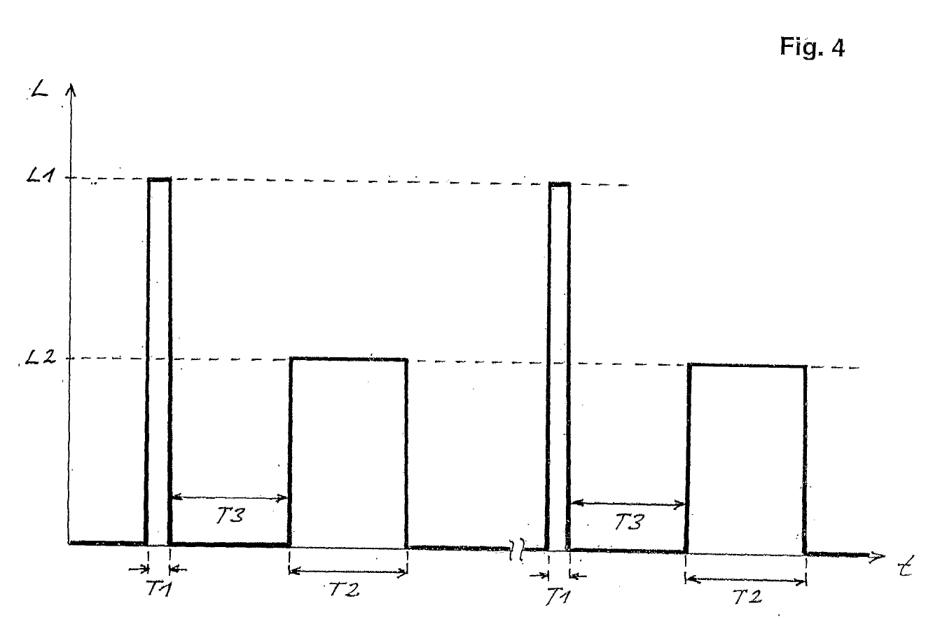

FIG. 2 is a block diagram of another part of the system according to the invention intended to illustrate its means for detecting and processing grinding material information. The light source 24 is located to the right of the gap 10, and the camera 12 to the left thereof (projection version). The light-permeable walls 20, 22 (see FIG. 1) are not shown here. The light source 24 is synchronized with the camera 12 by a timing generator 26, thereby resulting in a stroboscope 24, 26 and a camera with a synchronous activation time with the stroboscope. The camera 12 hence records still images of the shadows cast by the grinding material particles. The signal output of the camera 12 is connected to a computer 14, which is used for image processing and statistical evaluation of the grinding material stills (compare FIG. 3). The timing generator or clock generator 26 can be used to select the flash duration of the stroboscopic lamp 24 and activation time of the camera 12 as desired (compare FIG. 4).

FIG. 3 shows a part of the process of detecting and processing the grinding material image information. The images detected in the camera 12 can be more or less perfect, i.e., sharp, stills. After the camera has been focused at the particles in the gap 10, the sharpness of a particle image or particle shadow also depends on the particle velocity. Since no laminar flow is generally present in the gap 10 and not necessarily intended (turbulence can have a deagglomerating effect), the various grinding material particles in the presentation section or visual field of the camera 12 have rather disparate velocities. As a result, some of the particle images may be sharp, and others blurry or fuzzy in the direction of the particle velocity.

Detection first requires that the gap in the visual field of the camera 12 be illuminated as uniformly as possible. This is especially important for the reflection version, since a low contrast could otherwise result between the light reflected by the particles and the light reflected by the light-impermeable wall 22 (not shown).

In addition to illuminating the gap 10 as homogeneously as possible and having the sharpest possible focus on the gap as both mentioned above, attention should also be paid to providing sufficient depth of field, so that the image is sharp enough over the entire gap width even at a greater gap distance measuring in excess of one centimeter.

It may also be advantageous to set a particularly small depth of field ranging from about 0.2 to 2 mm. As a result, only a portion (sharp image plane) of the detection area in which the particles are entrained in the fluid stream are detected for evaluation. This “optical filtering” makes it possible to cut the overall number of particles moving in the detection area to a statistically relevant figure. This is important, for example, to preclude the overlapping of particle images or shadow images as much as possible.

Once all of these measures have been taken and optimized, the resultant obtained raw images of the image sensor of the camera 12 can be processed even further.

As shown on FIG. 3, the raw images of the camera are digitally processed to this end (pixel filters). An inhomogeneous illumination or brightness is here first corrected in the particle images and image background or in the particle shadows.

Sharp particles or particle images are then selected, which are then passed on to further evaluation. As a rule, this selection can be assumed to be representative for the entirety of all particle images. Should this not be the case, several cameras 12 can be used in various parts of the gap 10, and the raw images or sharp particle images or particle shadows selected from them can be averaged.

The particles or particle images or particle shadows are then measured, and a volume approximation is performed. As a rule, it will here be assumed that the maximum dimensions Dmax of a grinding material particle and minimum dimensions Dmin of a grinding material particle will differ by no more than a factor of two for a typical milled grain product (e.g., wheat, barley, rye), i.e., Dmax≦2 Dmin. For example, the minimum dimension a and maximum dimension b of a particle image or particle shadow can be drawn upon to determine the average value M=(a+b)/2, which in turn is multiplied by a geometric factor or shape factor k common for the grinding material particle shape, yielding V=function (a,b)=k m³=k [(a+b)/2]³ as the volume approximation. As an alternative, the volume can also be approximated with the function V=k a² b. Since the particles to be analyzed are shaped like platelets in the case at hand, it is also possible to replace the volume by the projection area of the particles, i.e., the third dimension (thickness) is constant, and is included in the geometric constant k.

The average particle dimensions m or volume approximations V obtained in this way from the particle images or particle shadows are then statistically evaluated and plotted on a histogram.

FIG. 4 shows a special aspect involved in the detection and processing of optical grinding material information. The vertical axis depicts the flash light intensity L. The horizontal axis shows time t. The progression of flash light over time reveals a short, intensive stroboscopic flash still followed somewhat later by a stroboscopic flash trajectory image. Since the time interval between two consecutive stroboscopic flash stills can be one hundred or even one thousand times greater than the activation time of a stroboscopic flash, the time axis is shown interrupted.

The particle images or particle shadows can be detected with a series of stroboscopic flashes, which exhibit a first partial series of stroboscopic flash stills having a first activation time T1 and a first light intensity L1 as well as a second partial series of stroboscopic trajectory images with a second actuation duration T2≧2 T1 and a second light intensity L2<L1.

The deactivation time T3 between the stroboscopic flash still and the stroboscopic flash trajectory image satisfies the relationship 2 D<vT3<10 D, and in particular the relationship 2 D<v T3<7 D.

In order to obtain sufficiently sharp, i.e., virtually “non-fuzzy” or “non-blurry” still images of the moving particles, the activation time T1 of the stroboscopic flash still images should satisfy the relationship v T1<<D, and in particular the relationship v T1<D/10.

To obtain clear trajectory images that cannot be confused with still images of extremely oblong grinding material particles, the activation time T2 of the stroboscopic flash trajectory images should satisfy the relationship v T2>D, and in particular the relationship v T2≧5 D.

Independently of the features mentioned above, it is advantageous if the light intensity L1 of the stroboscopic flash still images and light intensity L2 of the stroboscopic flash trajectory images are different from each other. This can also be drawn upon for distinguishing between the resultant stills and trajectory images.

The particle stills, to which a particle trajectory can be allocated, can be stored in a first still image memory, so that the respective particle still image information is stored in a still image memory for each completed stroboscopic flash still image and stroboscopic flash trajectory image.

While the foregoing description and drawings represent the present invention, it will invention, it will be obvious to those skilled in the art that various changes may be made therein made therein without departing from the true spirit and scope of the present invention.

### Reference List

1 Grinding material sample/particle stream

2 Roll

4 Roll

6 Roll passage

8 Removal means, funnel

10 Presentation section, gap

12 Detection means for electromagnetic radiation, camera

14 Analyzing means, image processing system

16 Deagglomeration section, impact surface

18 Pneumatic line

19 Port area

20 First wall

22 Second wall

24 Electromagnetic radiation source, light source

26 Controller, timer generator

28 Transition area

30 Pneumatic line

32 Bypass, branch line

34 Throttle valve

36 Air intake, vacuum cleaner (return to mill).

38 Secondary air opening

L1 First intensity

L2 Second intensity

T1 First activation time

T2 Second activation time

T3 Deactivation time

D Average particle size of grinding material particles

Dmin Minimum particle dimensions of a grinding material particle

Dmax Maximum particle dimensions of a grinding material particle

1-51. (canceled)

52. A system for characterizing the particles in a particle stream, said system comprises:
removal means for taking a sample out of the particle stream;
a presentation section for conveying and presenting the sample taken;
acquisition means for detecting the sample conveyed through the presentation section;
analyzing means for analyzing the detected sample,
said detection means having a camera with a visual field for detecting electromagnetic radiation or electromagnetic frequencies, such as optical frequencies;
opposing walls of the presentation section being permeable to electromagnetic radiation detectable by the camera, including optical frequencies;
said camera being situated downstream on one side of a gap on one of two permeable walls; and
an electromagnetic radiation source, such as a light source, for the electromagnetic radiation detectable by the camera being situated downstream on the other side of the gap on the other of the two permeable walls, so that the sample particles conveyed through the gap can be radiated by the electromagnetic radiation, and the shadow or projection of the sample particles gets into the visual field of the camera.

53. The system according to claim 52, wherein a deagglomeration section is provided downstream from the removal means and upstream from or in the presentation section for deagglomerating particle agglomerates in the sample.

54. The system according to claim 52, wherein the removal means is connected by a pneumatic line with the presentation section in such a way that the sample can be conveyed through the pneumatic line and presentation section along a flow path

55. The system according to claim 52, wherein the presentation section has two opposing walls, between which a gap is formed.

56. The system according to claim 55, wherein the two opposing walls exhibit flat surfaces arranged parallel to each other.

57. The system according to claim 55, wherein the pneumatic line ends in a port area in the gap formed between the opposing walls.

58. The system according to claim 57, wherein the flow path in the port area exhibits a directional change.

59. The system according to claim 58, wherein the directional change measures between 30° and 90°.

60. The system according to claim 59, wherein the directional change measures between 80° and 90°.

61. The system according to claim 52, wherein a cleaning device is allocated to the respective opposing walls (20, 22), and can be used to remove particles adhering to the two opposing walls.

62. The system according to claim 61, wherein the cleaning device is vibration source, in particular an ultrasound source, which is rigidly secured to the respective two opposing walls, so that the two walls can be made to vibrate.

63. The system according to claim 61, wherein the cleaning device can also be a vibration source, such as an ultrasound source, with which the gaseous medium between the two opposing walls can be made to vibrate.

64. The system according to claim 53, wherein the deagglomeration section (16) is an impact surface in the entry area of the presentation section.

65. The system according to claim 64, wherein the directional change in the flow path takes place in the entry area of the presentation section.

66. The system according to claim 54, wherein the presentation section is larger than the visual field of the camera, and the camera acquires a partial area of the presentation section.

67. The system according to claim 54, wherein the presentation section is larger than the visual field of the camera, and several camera each acquire a partial area of the presentation section.

68. The system according to claim 67, wherein the several cameras can each be selectively activated, so that selective sections of the particle stream image on the image sensor can be used.

69. The system according to claim 54, wherein the presentation section can essentially correspond to the entire visual field of the camera, and the image sensor of the camera can be selectively actuated, so that selective sections of the particle stream image on the image sensor can be used.

70. The system according to claim 68, wherein the selective actuation takes place purely randomly, in particular through actuation by means of a random-check generator.

71. The system according to claim 64, wherein the light source and camera are best connected with a controller, which can synchronously turn the light source and camera on and off, so that a sequence of stroboscopic pictures are taken.

72. The system according to claim 64, wherein the analyzing means has an image processing system.

73. The system according to claim 72, wherein this image processing system has means for taking the particles imaged and detected by the camera in the projection mode or reflection mode and distinguish between moving particles and particles adhering to the walls.

74. The system according to claim 52, wherein it is used to characterize a particle stream exiting a cylinder mill, wherein the removal means is situated after the roll passage formed by a roll pair, and wherein the particle stream is a grinding material stream, and the sample is a grinding material sample.

75. The system according to claim 74, wherein it has several removal means after the roll passage arranged along the axial direction of a roll passage.

76. The system according to claim 75, wherein it has a first removal means in the area of the first axial end of the roll passage, and a second removal means in the area of the second axial end of the roll passage.

77. A method for characterizing the particles in a particle stream, using a system according to claim 52, comprising the following steps:
taking a sample from the particle stream;
conveying and presenting the sample taken in a presentation section;
detecting the sample conveyed through the presentation section;
analyzing the detected sample; and
radiating the sample particles conveyed through the gap by the electromagnetic radiation, and allowing the shadow or projection of the sample particles to get into the visual field of the camera.

78. The method according to claim 77, wherein the sample is conveyed through the presentation section in a radial stream.

79. The method according to claim 77, wherein the grinding material sample passed through the presentation section is detected in partial areas only.

80. The method according to claim 79, wherein, over the course of the entire detection process, at least one switch is made between a first partial area where a first part of the detection takes place to at least one additional partial area where another part of the detection subsequently takes place.

81. The method according to claim 79, wherein the respectively detected partial areas of the presentation section are selected at random.

82. The method according to claim 77, wherein a deagglomeration of particle agglomerates in the sample takes place before and/or during passage of the particle stream through the presentation section.

83. The method according to claim 82, wherein deagglomeration takes place before the sample passes through the presentation section predominantly through deflection and impact.

84. The method according to claim 82, wherein deagglomeration takes place as the sample passes through the presentation section primarily through turbulence in the pneumatic particle stream.

85. The method according to claim 79, wherein the samples taken are pneumatically conveyed before removed until presented.

86. The method according to claim 79, wherein the samples are removed, presented, detected and analyzed continuously.

87. The method according to claim 86, wherein the continuous particle stream is detected stroboscopically through a series of stroboscopic flashes.

88. The method according to claim 87, wherein detection takes place with a series of stroboscopic flashes, which exhibits a first partial series of stroboscopic flash still pictures with a first activation time T1 and first light intensity L1, and a second partial series of stroboscopic flash trajectory pictures with a second activation time T2 and a second light intensity L2, wherein the following relationship is satisfied: T2≧2 T1.

89. The method according to claim 88, wherein the light intensity L1 of the stroboscopic flash still images and light intensity L2 of the stroboscopic flash trajectory images differ.

90. The method according to claim 88, wherein the particle stills, to which a particle trajectory can be allocated, can be stored in a first still image memory, so that the respective particle still image information is stored in a still image memory for each completed stroboscopic flash still image and stroboscopic flash trajectory image.

91. The method according to claim 90, wherein the particle still image information for consecutive stills is then statistically evaluated, in particular to determine the average particle size D, its standard deviation, and its statistical distribution.

92. The method according to claim 77, wherein it is used to characterize a particle stream exiting a cylinder mill, wherein the sample is removed as the particle stream exits the roll passage formed by a roll pair, and wherein the particle stream is a grinding material stream, and the sample is a grinding material sample.

93. The method according to claim 76, wherein the grinding material sample is taken from the grinding material stream exiting the roll passage at various points.

94. A cylinder roll, comprising that it has allocated to it a grinding material characterization system according to claim 74 for characterizing the grinding stock stream.

95. The cylinder roll according to claim 94, wherein it also is allocated to
a comparison device for comparing a determined grinding material characteristic with a desired grinding material characteristic; and
a setting device for setting the gap distance or another cylinder mill operating parameter as a function of a deviation between the determined grinding material characteristic and the desired grinding material characteristic.
